(19) United States
(12) Patent Application Publication
(10) Pub. No.: US 2006/0107031 A1
(43) Pub. Date: May 18, 2006

(54) Portable terminal

(75) Inventors: Takashi Kouno, Tokyo (JP); Shinichi Shishino, Tokyo (JP); Yasuhiko Abe, Saitama (JP); Munehisa Tomioka, Tokyo (JP); Sakae Inoue, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/236,454

(22) Filed: Sep. 27, 2005

(30) Foreign Application Priority Data
Nov. 18, 2004 (JP) 2004-334491

(51) Int. Cl. G06F 9/24

(52) U.S. Cl. 713/2

(57) ABSTRACT

Screen display matched to the progress of execution of the initialization function in small and inexpensive devices such as a portable terminal is performed. Furthermore, reliability in the event of an error is improved without providing excessive redundancy and with limited capacity in a NAND flash memory storing programs. A first boot layer and a second boot layer of the same content are stored in the NAND flash memory. The boot layer free from errors is copied (C2) to a RAM (step S21), and a boot layer program is executed in the RAM (step S30). A simple logo and the like comprising characters is then displayed (first screen display) (step S32). Next, a system layer program is executed in the RAM (step S40). A screen (second screen display) is then displayed by switching between a plurality of images (step S44).

### CROSS-REFERENCE TO RELATED APPLICATIONS

This application is based upon and claims the benefit of priority from the prior Japanese Patent application No. 2004-334491, filed on Nov. 18, 2004; the entire contents of which are incorporated herein by reference.

### BACKGROUND OF THE INVENTION

1. Field of the Invention

The present invention relates to boot processing, being processing at memory system startup, in a portable terminal, and more particularly to image display at boot, improved reliability, and improved efficiency of manufacturing testing.

2. Description of the Related Art

Related Art 1

For example, as disclosed in Japanese Patent Application Laid-open No. 2003-271391, a boot system using a NAND flash memory, and a related method, are known.

On p 4 of the ‘Prior Art’, and in FIG. 1, of the Japanese Patent Application Laid-open No. 2003-271391, it is disclosed that the BIOS is a program executing an initialization function including a display function. The BIOS is stored in the NAND flash memory, and is loaded into the system memory and executed.

Furthermore, on p 6, p 7, and p 11 of the ‘Embodiments of the Invention’, and in FIG. 2 and FIG. 3, of the Japanese Patent Application Laid-open No. 2003-271391, the boot code, the OS, and other programs are stored in the NAND flash memory. The bootstrapper provided externally to the NAND flash memory loads the boot code in the NAND flash memory into the internal RAM. The initialization function within the boot code is then executed, and the OS in the NAND flash memory is loaded into the system memory with the copy loop command in the boot code. The OS is then executed in the system memory. All programs and files related to the OS are then loaded into the system memory, and the system driven by the OS.

Related Art 2

For example, as disclosed in Japanese Patent Application Laid-open No. 2004-118826, a system device booted using a flash memory, and a related boot method, are known.

On p 5 through p 7, and in FIG. 1, FIG. 2, and FIG. 5 of the Japanese Patent Application Laid-open No. 2004-118826, it is disclosed that the handler and loader, the boot code, the OS code, and the application code are stored in the flash memory. At initialization following power on, the handler and loader are loaded automatically into the register, the handler is executed in the register, and the loader is loaded into the system memory. The loader is then executed in the system memory, and the boot code and OS code are then loaded into the system memory.

In the device and method disclosed in Japanese Patent Application Laid-open No. 2003-271391 and Japanese Patent Application Laid-open No. 2004-118826, it is disclosed that the BIOS executing the initialization function includes a display function, however, details of the display function are not disclosed. Furthermore, response to errors in the NAND flash memory is not disclosed. Furthermore, nothing related to manufacturing testing of the device is disclosed. Furthermore, nothing related to errors occurring in the system memory following loading into the system memory from the NAND flash memory is disclosed.

### SUMMARY OF THE INVENTION

The present invention is for solving the afore-mentioned problems, and has as an object the provision of image display matched to the progress of execution of the initialization function in a small and inexpensive device such as a portable terminal.

To achieve the afore-mentioned object, an aspect of the present invention provides a portable terminal including: a non-volatile memory configured to store at least a boot program, a system program, and an application program; a system memory; a display; a first copy control unit configured to copy to the system memory the boot program stored in the non-volatile memory at power on; a second copy control unit configured to copy to the system memory the system program stored in the non-volatile memory by executing the boot program copied to the system memory; a third copy control unit configured to copy to the system memory the application program stored in the non-volatile memory by executing the system program copied to the system memory; a first display control unit configured to display a first screen on the display when the system program is copied by the second copy control unit; a second display control unit configured to display a second screen on the display when the application program is copied by the third copy control unit; and a third display control unit configured to display a third screen on the display by executing the application program copied to the system memory.

According to the present invention, image display matched to the progress of execution of the initialization function in a small and inexpensive device such as a portable terminal is possible. Furthermore, while using inexpensive NAND flash memories, it is possible to improve reliability in the event of an error with limited NAND flash memory without providing redundancy.

Furthermore, manufacturing testing of the portable terminal may be implemented rapidly at the completion of loading of the loader, boot code (boot layer), and OS code, rather than at the completion of loading of the loader, boot code (boot layer), OS code, and application code stored in the NAND flash memory to the system memory and the like.

Furthermore, after loading from the NAND flash memory to the system memory, reliability in the event of an error in the system memory may be improved.

### BRIEF DESCRIPTION OF THE DRAWINGS

FIG. 1 is block diagram showing the configuration of the primary components of the portable terminal according to all embodiments of the present invention;

FIG. 2 is a diagram describing the boot mechanism at power on for a portable terminal according to the first embodiment of the present invention;

FIG. 3 is a general flowchart for a portable terminal according to the first embodiment of the present invention at boot;

FIG. 4 is a general flowchart for a portable terminal according to the first embodiment of the present invention at boot;

FIG. 5 is a general flowchart for a portable terminal according to the second embodiment of the present invention at boot;

FIG. 6 is a detailed flowchart for a portable terminal according to all embodiments of the present invention at boot; and

FIG. 7 is a detailed flowchart related to processing of errors occurring during execution in the RAM of the portable terminal according to all embodiments of the present invention.

### DETAILED DESCRIPTION OF THE INVENTION

Embodiments of the present invention are described below in reference to the figures.

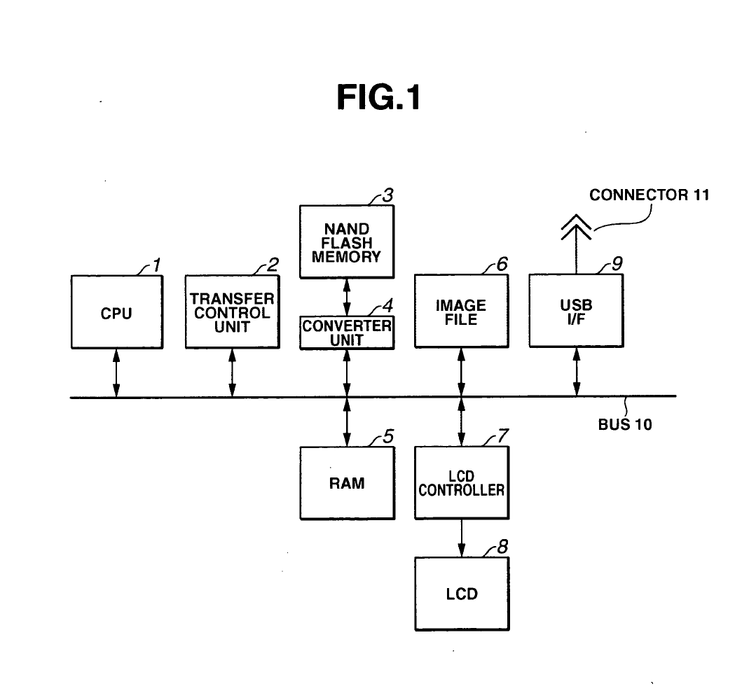

FIG. 1 is block diagram showing the configuration of the primary components of the portable terminal according to all embodiments of the present invention. The primary components of the portable terminal are comprised of a CPU 1, a transfer control unit 2, a NAND flash memory 3, a converter unit 4, a RAM 5, an image file 6, an LCD controller 7, an LCD 8, a USB I/F 9, a bus 10, and a connector 11 and the like.

The CPU 1 conducts overall control. The transfer control unit 2 transfers data between the memory and I/O. The NAND flash memory 3 is an inexpensive sequential access, non-volatile, batch-erased memory which cannot be randomly accessed in byte or word units, and in which various programs and the like are stored beforehand. Since random access is not possible, the CPU 1 cannot directly execute various programs in the NAND flash memory 3.

The converter unit 4 has a function to bi-directionally convert the sequential access data format of the NAND flash memory 3 to the random access format. The RAM 5 is a high-speed system memory and is used as a program execution area and the like. The various programs stored in the NAND flash memory 3 are temporarily copied (loaded) to the RAM 5 area, and then executed by the CPU 1 in the RAM 5.

The image file 6 stores image data at startup at portable terminal power on, and other image data. The LCD controller 7 controls the liquid crystal display unit LCD 8. The USB I/F 9 is an interface between an external device (not shown in figures) of the portable terminal, and is connected to the external device by the connector 11.

The memory storing the programs beforehand may be a sequential access memory for which random access is not possible such as a HDD (Hard Disk Drive) and the like, in place of the NAND flash memory host device 3.

Furthermore, the memory storing the programs beforehand may be an inexpensive low-speed ROM for which random access is possible. The converter unit 4 is unnecessary in this case. However, due to the low speed, programs may be similarly loaded temporarily from the low-speed ROM to the high-speed system memory, and then executed in the high-speed system memory.

Furthermore, some of the programs may be stored beforehand in a memory other than the NAND flash memory 3.

### FIRST EMBODIMENT

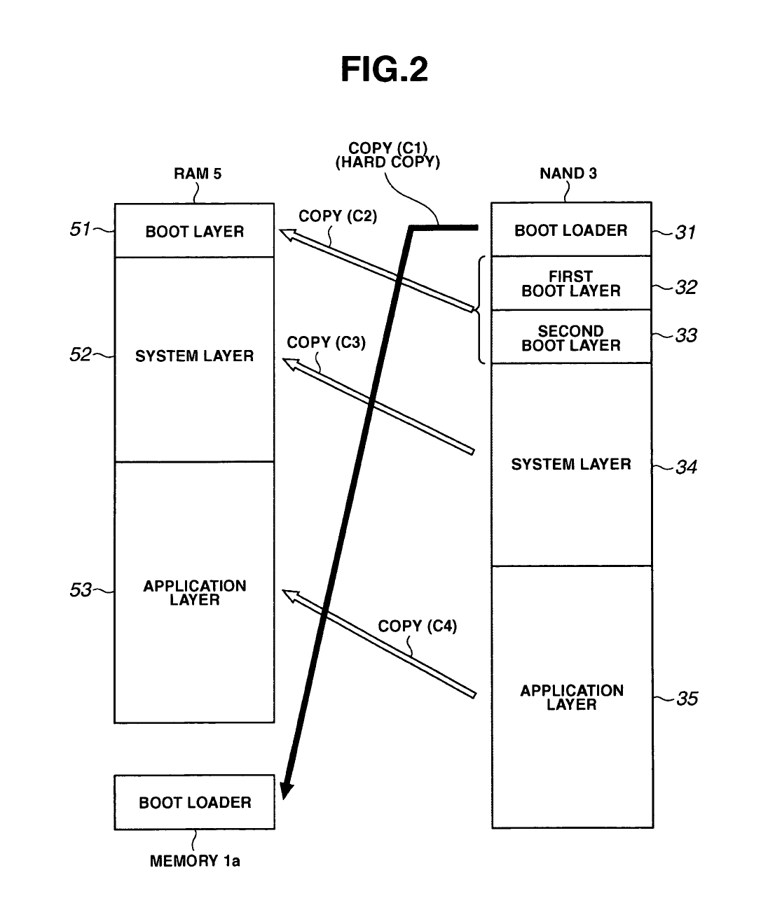

FIG. 2 is a diagram describing the boot mechanism at power on for a portable terminal according to the first embodiment of the present invention. Boot is a mechanism for loading (copying) programs from the program storage area to the system memory and the like, and the CPU initializing these programs in system memory, at power on.

The boot loader 31, the first boot layer 32, the second boot layer 33, the system layer 34, and the application layer 35 programs are stored in the NAND flash memory 3 beforehand. The boot loader 31 (that is to say, the loader of the boot layer) is a program to load (copy C2) the first boot layer 32 or the second boot layer 33 into the boot layer 51 of the RAM 5.

The content of the first boot layer 32 and the content of the second boot layer 33 are the same, two boot layers being provided for the purpose of backup. This program has a function to initialize screen display and the like at startup as required for initialization following portable terminal power on. Furthermore, there is also a program to load (copy C3) the system layer 34 into the system layer 52 of the RAM 5. The size of the programs in this boot layer is comparatively small. In a small and inexpensive device such as the portable terminal, the NAND flash memory 3 cannot have sufficient redundant capacity. Therefore, by providing two of this boot layer for the purpose of backup, the reliability of the portable terminal can be improved with only a small increase in capacity.

The system layer 34 has an OS function, and furthermore, has a program to load (copy C4) the application layer 35 into the application layer 53 of the RAM 5.

The application layer 35 has an application program.

The memory 1a is a memory and register in which the CPU 1 can execute the program at high-speed, and may be provided within the CPU 1 or the RAM 5, or may be another memory.

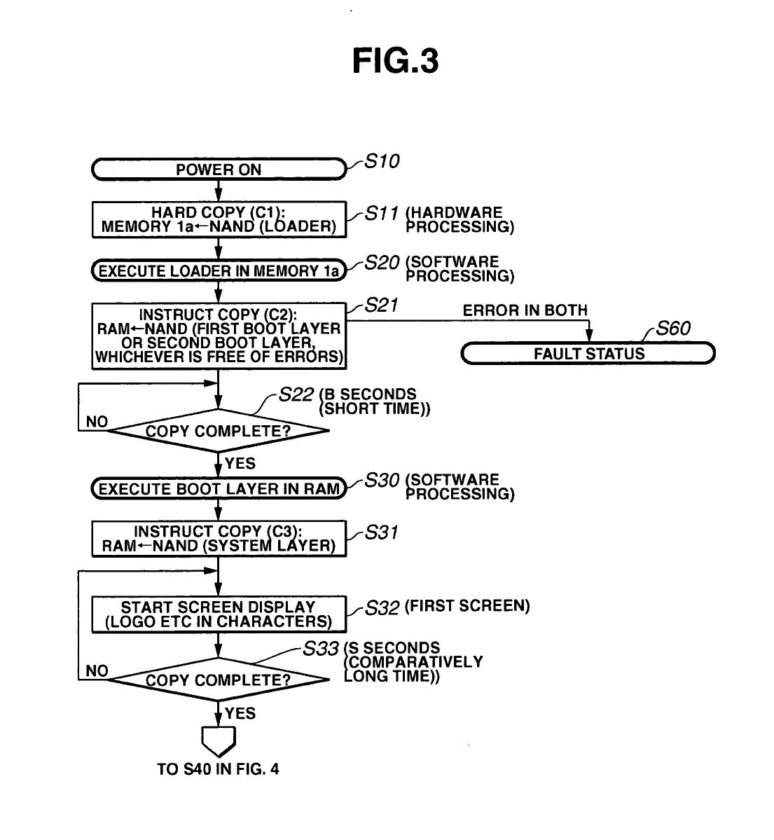

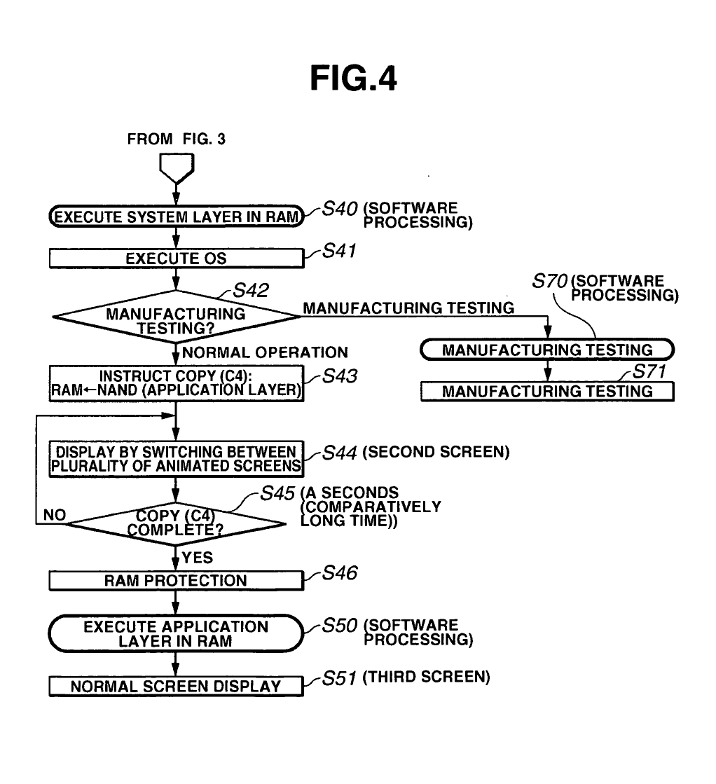

FIG. 3 and FIG. 4 are general flowcharts for a portable terminal according to the first embodiment of the present invention at boot.

These flowcharts also employ FIG. 2 in describing the operation of the multi-stage boot mechanism.

At portable terminal power on (step S10), the boot loader 31 in the NAND flash memory 3 is hard-copied (C1) to the memory 1a (step S11) by hardware processing of the transfer control unit 2. Since there is no program which can be executed by the CPU 1 in the random access memory 1a and RAM 5 immediately following power on, a hard copy (C1) is executed purely by hardware processing without intervention of the CPU 1.

When this hard copy (C1) (step S11) is complete, the CPU 1 is in a state in which operation is possible in the memory 1a, and the CPU 1 begins execution of the boot loader (step S20) in the memory 1a. Here, the CPU 1 reads the first boot layer 32 or the second boot layer 33 in the NAND flash memory 3 via the converter unit 4 and checks for errors, in accordance with the content of the boot loader. The CPU 1 then instructs the transfer control unit 2 to copy (C2) the first boot layer 32 or the second boot layer 33, whichever is free of errors, to the boot layer 51 of the RAM 5 (step S21).

When the initial boot being the execution of the boot layer fails, the subsequent system layer and application layer cannot be booted, however, by providing two boot layers, the reliability of the initial boot layer can be improved, and the boot can continue to the later stage. Furthermore, since at least the image is displayed at startup even if the boot ends only with execution of the initial boot layer, display of faults and the like is possible.

When errors which cannot be corrected occur in the both the first boot layer 32 and second boot layer 33 of the NAND flash memory 3, the boot cannot proceed, and the fault status occurs (step S60). All action by the CPU 1 is inhibited in this status.

The transfer control unit 2 conducts high-speed transfer (copy C2) such as DMA (Direct Memory Access). The CPU 1 checks progress of the copy (C2) (step S22) and awaits completion of the copy. Assuming the prescribed time for the copy (C2) to be B seconds, this copy is completed in a short time due to the small size of the first boot layer 32 and second boot layer 33 programs.

When this copy (C2) is complete (YES in step S22), the CPU 1 then begins execution of the boot layer 51 copied (C2) to RAM 5 (step S30). Here, the CPU 1 instructs the transfer control unit 2 to copy the copy (C3), in other words, the system layer 34 in the NAND flash memory 3, to the system layer 52 in the RAM 5 in accordance with the content of the boot layer 51, and the copy (C3) is then begun (step S31). Furthermore, the CPU 1 conducts processing for display of the startup screen (step S32, first screen). This processing sends the startup screen in the image file 6 to the LCD controller 7, and induces the LCD controller 7 to display the startup screen on the LCD 8. This screen is a simple screen in which a logo and the like is displayed in characters (first screen), and is displayed B seconds after power on so that the portable terminal user can see the startup screen immediately and be provided with a sense of security.

Display of this simple screen of a logo and the like in characters (first screen) continues until the system layer copy (C3) is complete (step S33). Assuming the time required as S seconds, a few seconds is required for this copy due to the large program size of the system layer 34, and the user generally experiences this as a long wait.

When this copy (C3) is complete (YES in step S33), the CPU 1 begins execution of the system layer 52 copied (C3) to the RAM 5 (step S40, FIG. 4).

In FIG. 4, the CPU 1 executes the OS in accordance with the content of the system layer 52 (step S41). The hardware functions of the portable terminal are operable at this time.

Next, a check is conducted to determine whether the portable terminal is in the manufacturing testing mode employed by the manufacturer at the manufacturing plant, or in normal operation by the user (step S42). This is determined by, for example, checking whether or not the external device is connected to the portable terminal connector 11, and the manufacturing testing instruction is input from the external device. When there is no manufacturing testing instruction input, normal operation is assumed, and the CPU 1 instructs the transfer control unit 2 to conduct the copy (C4), in other words, copy the application layer 35 in the NAND flash memory 3 to the application layer 53 in the RAM 5, and copy (C4) begins (step S43). Furthermore, the CPU 1 displays screens by switching between a plurality of images (step S44, second screen). This display is conducted by switching between a plurality of screens to provide the user with a sense that operation is continuing.

Screen display (second screen) continues by switching between this plurality of screens until the application layer copy (C4) is complete (step S45, A seconds). This copy requires a few seconds due to the large program size of the application layer 35, and the user generally experiences this as a long wait. During this time, screen display can be by switching between a plurality of screens, rather than displaying the same screen continuously.

Copying of the program to the RAM 5 is completed with completion of this copy (C4) (YES in step S44), and the RAM is protected (step S46) to prevent loss of program data in RAM 5.

Next, the CPU 1 begins execution of the application layer 53 copied (C4) to the RAM 5 (step S50). By executing this application layer 53, the regular screen is displayed (step S51, third screen). A detailed description of other than application layer 53 is omitted.

Here, the CPU 1 begins manufacturing testing (step S70) with ‘manufacturing testing’ in step S42. Manufacturing testing of the portable terminal is then executed (step S71). This manufacturing testing (step S70) is conducted without copying (C4) the application layer (step S45), and without screen display (display of the second screen) by switching between the plurality of images which is unnecessary for manufacturing testing. Therefore, manufacturing testing can be executed immediately S seconds (a few seconds) required for copy (C3) of the system layer after portable terminal power on, and the time required for the manufacturing process can be shortened.

According to the first embodiment, the user can view the simple screen of a logo and the like in characters (first screen) immediately following power on, and can view the screen display by switching between a plurality of screens during copying of the system layer, and gain a sense of security.

### SECOND EMBODIMENT

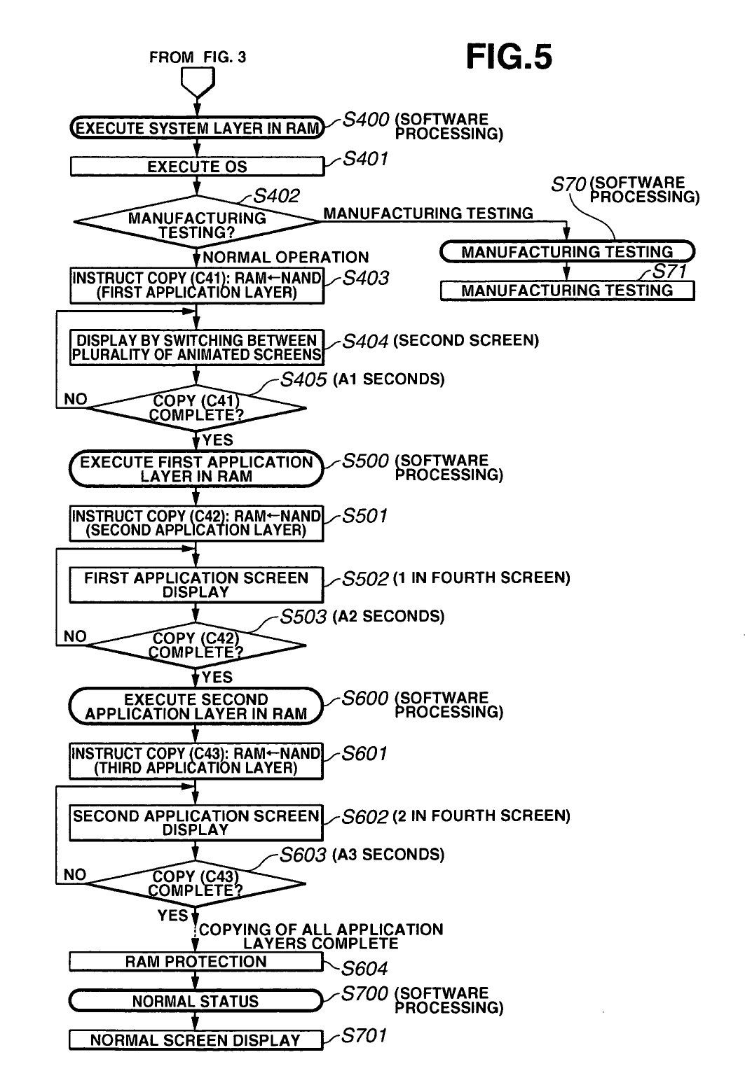

FIG. 5 is a general flowchart for a portable terminal according to the second embodiment of the present invention at boot. In the present embodiment, the application layer 35 in the NAND flash memory 3 (FIG. 2) is further divided into a plurality of application layers, each application layer being copied to the RAM 5, and executed in the RAM 5. The part of the general flowchart (1/2) (FIG. 3) at boot in the first embodiment describes the same operation and the part of the general flowchart (2/2) (FIG. 4) subsequently executed differs. This is described using FIG. 5.

When copying of the system layer 34 to the RAM 5 is complete, execution of the system layer in the RAM begins (step S400). The CPU 1 executes the OS (step S401) in accordance with the content of the system layer 52 in the RAM 5. At this time, the hardware functions of the portable terminal are all operable. Manufacturing testing (steps S402, S70) is the same as for the first embodiment (FIG. 4), and a description is omitted.

In this case of ‘normal operation’ in (step S402), the CPU 1 instructs the transfer control unit 2 to conduct copy (C41), in other words, to copy the first application layer of the application layer 35 in the NAND flash memory 3 to the relevant area of the application layer 53 in the RAM 5, and copy (C41) begins (step S403). Furthermore, the CPU 1 displays screens by switching between a plurality of images (step S404, second screen).

Screen display (second screen) continues by switching between this plurality of screens until the first application layer copy (C41) is complete (step S405, A1 seconds).

When copying of the first application layer of the application layer 35 to the RAM 5 is complete, execution of the first application layer in the RAM begins (step S500). The CPU 1 instructs the transfer control unit 2 to conduct copy (C42), in other words, to copy the second application layer of the application layer 35 in the NAND flash memory 3 to the relevant area of the application layer 53 in the RAM 5, in accordance with the content of the first application layer in the RAM, and begin (C42) begins (step S501). Furthermore, the CPU 1 displays the first application screen (step S502, 1 in fourth screen).

This first application screen display (1 in fourth screen) continues until the second application layer copy (C42) is complete (step S503, A2 seconds).

When copying of the second application layer of the application layer 35 to the RAM 5 is complete, execution of the second application layer in the RAM begins (step S600). The CPU 1 instructs the transfer control unit 2 to conduct copy (C43), in other words, to copy the third application layer of the application layer 35 in the NAND flash memory 3 to the relevant area of the application layer 53 in the RAM 5, in accordance with the content of the second application layer in the RAM, and copy (C43) begins (step S601). Furthermore, the CPU 1 displays the second application screen (step S602, 2 in fourth screen).

This second application screen display (2 in fourth screen) continues until the third application layer copy (C43) is complete (step S603, A3 seconds).

Subsequently, a plurality of application layers are similarly copied, executed, and displayed in sequence, and copying of the programs to the RAM 5 is complete when copying of all application layers is completed. The RAM is then protected (step S604) to prevent loss of program data in the RAM 5.

The portable terminal then enters the regular status (step S700), and the normal regular screen is displayed (step S701).

According to the second embodiment, the user can view the simple screen of a logo and the like in characters (first screen) immediately following power on, and can view the screen display by switching between a plurality of screens during copying of the system layer, and can view each application screen (1, 2 in fourth screen) matched to the progress of copying of each application during copying of all application layers, and gain a sense of security.

### COMMON TO ALL EMBODIMENTS

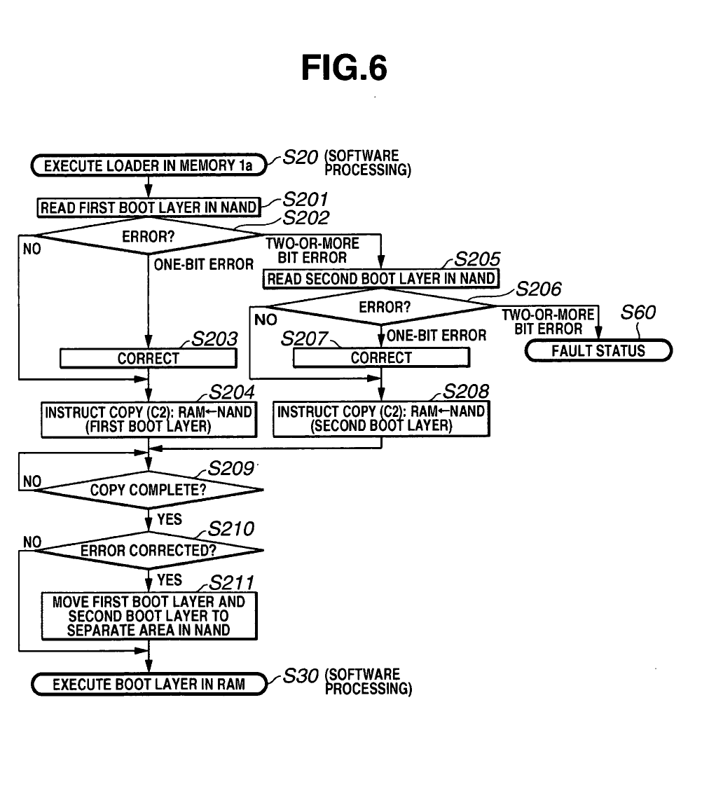

FIG. 6 is a detailed flowchart for a portable terminal according to all embodiments of the present invention at boot, and describes execution of the loader in the memory 1a (step S20) in detail shown in FIG. 3. Details of operation providing two boot layers (first boot layer 32 and second boot layer 33) in the NAND flash memory 3, and improving reliability, are described.

When the CPU 1 begins execution of the loader in the memory 1a (step S20), the CPU 1 reads the first boot layer 32 in the NAND flash memory 3 (step S201), and checks for errors by CRC (step S202). If no errors are detected (NO in step S202), the CPU 1 instructs copy (C2) of the first boot layer 32 (step S204). In the case of a ‘one-bit error’ in step S202, since correction is possible, the CPU 1 conducts correction processing (step S203), and then instructs copy (C2) of the first boot layer 32 (step S204).

In the case of a ‘two-or-more bit error’ in step S202, since correction is not possible, the CPU 1 reads the second boot layer 33 in the NAND flash memory 3 (step S205), and checks for errors (step S206). If no errors are detected (NO in step S206), the CPU 1 instructs copy (C2) of the second boot layer 33 (step S208). In the case of a ‘one-bit error’ in step S206, since correction is possible, the CPU 1 conducts correction processing (step S207), and then instructs copy (C2) of the second boot layer 33 (step S208).

In the case of a ‘two-or-more bit error’ in step S206, since correction is not possible, and correction of the first boot layer 32 is also not possible, further processing cannot be executed, and a fault state (step S60) occurs. The CPU 1 is unable to conduct any processing in this state.

Since natural recovery of the NAND flash memory 3 is also possible, processing in step S201 through step S208 may be repeated, rather than suddenly entering the fault state (step S60).

By providing two boot layers having the same content in this manner, the error rate becomes the square of each individual error rate, and reliability can be improved. The program size of this boot layer is comparatively small. In a small and inexpensive device such as a portable terminal, the NAND flash memory 3 cannot have sufficient redundant capacity. Therefore, by providing two of this boot layer for the purpose of backup, the reliability of the portable terminal can be improved with only a small increase in capacity.

When the copy (C2) is executed normally, the CPU 1 awaits completion of the copy (C2) (step S209). When the copy (C2) is complete (YES in step S209), a check is conducted (step S210) to determine whether or not a one-bit error was corrected in steps S203 and S207. If a one-bit error was corrected (YES in step S210), the first boot layer 32 and second boot layer 33 in the NAND flash memory 3 are moved to a separate physical area in the NAND flash memory 3 (step S211). This indicates that a one-bit error was corrected, and that a one-bit error existed, and furthermore, moves the physical area to improve reliability.

The physical area at this movement destination becomes the boot target at next power on.

When execution of the loader is complete, execution of the next boot layer in the RAM begins (step S30).

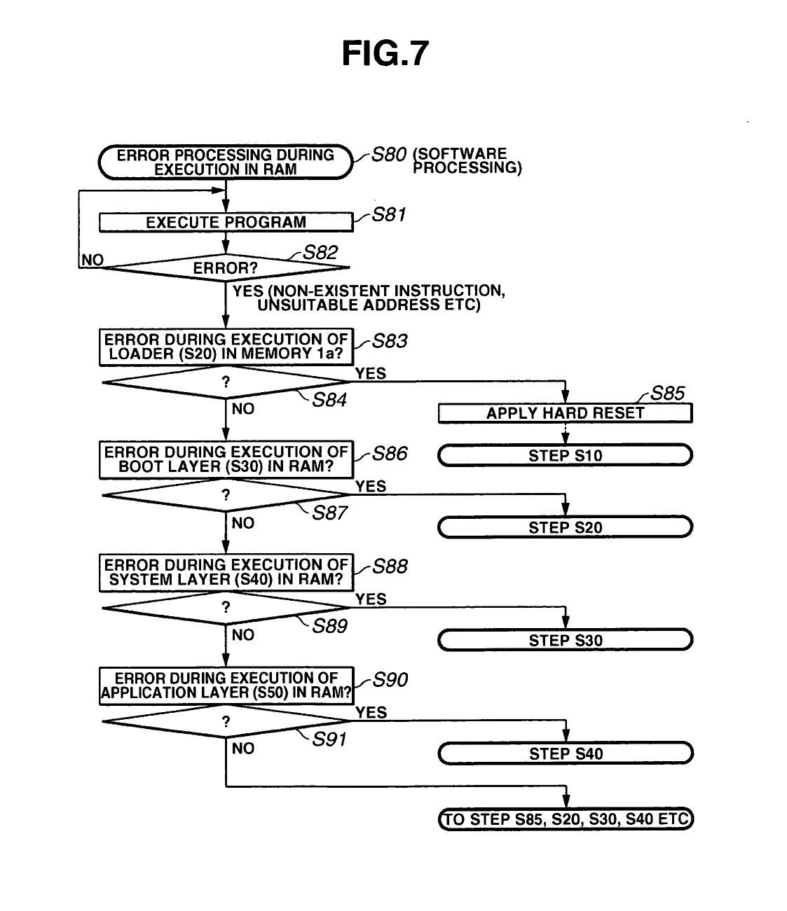

FIG. 7 is a detailed flowchart related to processing of errors occurring during execution in the RAM of the portable terminal according to all embodiments of the present invention. This applies to all or some of the errors during execution in the RAM. This applies to, for example, execution of the boot layer in the RAM in FIG. 3 (step S30), execution of the system layer in the RAM (step S40), execution of the application layer in the RAM (step S50), and execution in RAM of subsequent steps not shown in the figures.

The CPU 1 checks for errors (step S82) while executing the program (step S81). Errors are, for example, fetching a non-existent instruction, and accessing a hitherto non-existent address. When these errors are detected (YES in step S82), the CPU 1 applies hard reset to the portable terminal itself (step S85) if the currently executed program is the loader currently executed in the memory 1a (step S20) (YES in steps S83 and S84). Thus, startup is begun from step S1 by hardware processing, and the boot loader is again copied from the NAND flash memory to the memory 1a in step S10 (FIG. 3). Step S10 and subsequent steps are then executed.

When an error is detected during execution of the boot layer in the RAM (step S30) (YES in steps S86 and S87), processing jumps to step S20 (FIG. 3). Thus, the boot layer is again copied from the NAND flash memory to the RAM in step S20 (FIG. 3). Step S20 and subsequent steps are then executed.

When an error is detected during execution of the system layer in the RAM (step S40) (YES in steps S88 and S89), processing jumps to step S30 (FIG. 3). Thus, the system layer is again copied from the NAND flash memory to the RAM in step S30 (FIG. 3). Step S30 and subsequent steps are then executed.

When an error is detected during execution of the application layer in the RAM (step S50) (YES in steps S90 and S91), processing jumps to step S40 (FIG. 3). Thus, the application layer is again copied from the NAND flash memory to the RAM in step S40 (FIG. 3). Step S40 and subsequent steps are then executed.

When an error is detected during execution of any other layer in the RAM (NO in step S91), processing jumps to step S85, S20, S30 or S40 as appropriate. Thus, the layer is again copied from the NAND flash memory to the memory 1a and the RAM. Subsequent steps are then executed.

The jump destination at detection of an error is not limited to the above, and may return to any step in the appropriate upstream stage.

Thus, when an error occurs in the RAM and the like, the program stored in the NAND flash memory is again copied, and reliability can be improved.

What is claimed is:

1. A portable terminal comprising:
a non-volatile memory configured to store at least a boot program, a system program, and an application program;
a system memory;
a display;
a first copy control unit configured to copy to the system memory the boot program stored in the non-volatile memory at power on;
a second copy control unit configured to copy to the system memory the system program stored in the non-volatile memory by executing the boot program copied to the system memory;
a third copy control unit configured to copy to the system memory the application program stored in the non-volatile memory by executing the system program copied to the system memory;
a first display control unit configured to display a first screen on the display when the system program is copied by the second copy control unit;
a second display control unit configured to display a second screen on the display when the application program is copied by the third copy control unit; and
a third display control unit configured to display a third screen on the display by executing the application program copied to the system memory.

2. The portable terminal according to claim 1, wherein
the first display control unit displays the first screen on the display by executing the boot program copied to the system memory; and
the second display control unit displays the second screen on the display by executing the system program copied to the system memory.

3. The portable terminal according to claim 1, wherein the non-volatile memory stores at least two boot programs of the same content; and the first copy control unit selects a boot program which is free of errors from among the boot programs stored in the non-volatile memory, and copies the selected boot program to the system memory.

4. The portable terminal according to claim 1, wherein the non-volatile memory stores at least two boot programs of the same content, and the first copy control unit comprises:
a judging unit configured to judge whether or not a boot program read from the non-volatile memory can be corrected, and if correction is not possible, reading another boot program from the non-volatile memory to judge whether or not that boot program can be corrected;
a correction copy control unit configured to correct the boot program read from the non-volatile memory and copying the boot program to the system memory when determined as correctable by the judging unit; and
a storage control unit configured to store the corrected boot program in a separate area of the non-volatile memory for reuse if the boot program read from the non-volatile memory is corrected by the correction copy control unit.

5. The portable terminal according to claim 1, wherein the non-volatile memory stores a plurality of different application programs, and the second display control unit displays fourth screens differing from each other on the display if copying of each application program is completed.

6. The portable terminal according to claim 1, wherein the first copy control unit comprises:
means for hard-wired copying a boot loader from the non-volatile memory to the memory; and
means for copying to the system memory the boot program stored in the non-volatile memory by executing the boot loader hard-wired copied to the memory.

7. The portable terminal according to claim 6, further comprising hard reset means for applying hard reset when an error is detected during execution of the boot loader hard-wired copied to the memory.

8. The portable terminal according to claim 1, further comprising means for re-copying the boot program, the system program, or the application program from the non-volatile memory to the system memory if an error is detected during execution of the boot program in the first copy control unit, during execution of the system program in the second copy control unit, or during execution of the application program in the third copy control unit.

9. The portable terminal according to claim 1, further comprising:
means for determining whether it is a manufacturing testing mode for conducting manufacturing testing if copying of the system program by the second copy control unit is complete; and
means for omitting the application program copying by the third copy control unit and executing the prescribed manufacturing testing, if it is the manufacturing testing mode.
